(19) United States
(12) Patent Application Publication
(10) Pub. No.: US 2016/0291847 A1
(43) Pub. Date: Oct. 6, 2016

(54) Method and Apparatus for Providing Application Context Tag Communication Framework

(71) Applicant: McKesson Corporation, San Francisco, CA (US)

(72) Inventors: Marianne Lee, Vancouver (CA); Eldon Allan Wong, Vancouver (CA); Itai Galili, Vancouver (CA)

(21) Appl. No.: 14/674,692

(22) Filed: Mar. 31, 2015

(51) Int. Cl. G06F 3/0484

(52) U.S. Cl. CPC G06F 3/04845; G06F 3/04847; G06F 3/04842

(57) ABSTRACT

A method, apparatus and computer program product are provided in order to provide an application tagging framework. An example of the method includes receiving, via a tag selection interface, an indication of selection of at least one tag corresponding to a set of tag information stored in a tag information datastore, accessing, using a tag loader element executing via a processor, the tag information datastore to obtain the set of tag information, determining, by the tag loader element, one or more applications associated with the set of tag information, generating, by the tag loader element, an instruction to each of the one or more applications based on the set of tag information, the instruction comprising data to cause a tagging component of each of the one or more applications to applying formatting to at least one component of a user interface to indicate content of the user interface associated with the set of tag information, and transmitting the instruction to teach of the one or more applications.

### TECHNOLOGICAL FIELD

Example embodiments of the present invention relate generally to methods and devices for altering application interfaces and, more particularly, to methods and apparatuses for providing a communication framework for tagging application interfaces to provide annotation capabilities for those applications.

### BACKGROUND

As medical technology has advanced, medical practitioners have been provided with more and more data from more and more disparate sources. A medical practitioner may interact with Electronic Health Records (EHR) applications, Picture Archiving and Communication Systems (PACS), electronic lab reports, a training file recording or playback application, audio recording playback applications, online articles and industry publications, and other various other applications when diagnosing a patient, creating a training program, or performing other day-to-day tasks. The practitioner may utilize data from several of these applications to perform a single task.

Unfortunately, these applications lack a unified framework for communicating with one another and allowing the medical practitioner to document identified correlations between data elements provided by different applications. If the practitioner creates a particular diagnosis based on a correlation between an abnormality noted in an x-ray and a laboratory test result, the practitioner has no way to document the correlation or otherwise note the thought process that resulted in the diagnosis within the context of the applications. Dictation applications, word processors, and old-fashioned pen and paper techniques may allow the practitioner to create a record of their thought process, but these records rely on the practitioner to remember and document each of the relevant details that resulted in the diagnosis. Review and analysis of such records requires the reviewer to launch each application and attempt to recreate the methodology and thought process employed by the original practitioner. Such processes may be prone to errors arising from incorrectly documented information, incorrect application configuration settings, and a lack of identification of correlations between data provided by different application user interfaces. Through applied effort, ingenuity, and innovation, Applicant has solved many of these identified problems by developing a technical solution that is embodied by the present invention, which is described in detail below.

### BRIEF SUMMARY

Methods, apparatuses and computer program products are therefore provided according to example embodiments of the present invention in order to implement a framework for enabling cross-application communication, logging, and contextual awareness to identify correlations between data presented across disparate applications. Embodiments may include a method for providing an application tagging framework. The method includes receiving, via a tag selection interface, an indication of selection of at least one tag corresponding to a set of tag information stored in a tag information datastore, accessing, using a tag loader element executing via a processor, the tag information datastore to obtain the set of tag information, determining, by the tag loader element, one or more applications associated with the set of tag information, generating, by the tag loader element, an instruction to each of the one or more applications based on the set of tag information, the instruction comprising data to cause a tagging component of each of the one or more applications to apply formatting to at least one component of a user interface to indicate content of the user interface associated with the set of tag information, and transmitting the instruction to teach of the one or more applications.

The at least one tag may include a plurality of tags and two or more of the plurality of tags may be associated with different applications. The formatting applied to each of the different applications may include at least one consistent formatting element. The at least one consistent formatting element may be at least one of a color, a line quality, or a shading pattern. The one or more applications may be at least one of a picture archiving and communications system application or an electronic health records application. The method may also include executing each of the one or more applications in response to receiving the indication of selection of the at least one tag. The set of tag information may include application context information. The application context information may be at least one of an open file or a display setting.

Embodiments may also include additional methods for providing an application tagging framework. For example, an embodiment of a method may include receiving, via an application interface operating in conjunction with a computer processor, a first set of tag information associated with a first application, the first set of tag information derived from at least one first annotation performed on an first application interface associated with the first application by a tagging component of the first application, receiving, via the application interface, a second set of tag information associated with a second application, the second set of tag information derived from at least one second annotation performed on a second application interface associated with the second application by a tagging component of the second application, receiving at least one narrative associated with both the first set of tag information and the second set of tag information, storing the first set of tag information, the second set of tag information, the narrative, and an indicator of association among the first set of tag information, the second set of tag information, and the narrative in a tag datastore, and providing an interface for selection of an identifier, such that selection of the identifier causes the first annotation to be performed on the first application interface and the second annotation to be performed on the second application interface.

The first annotation and the second annotation may share at least one consistent formatting element. The application context information may include at least one of an open file or a display setting. Causing the first annotation to be performed on the first application may include configuring the first application with the application context information.

Yet further embodiments may include an apparatus for providing an application tagging framework. The apparatus includes a tag information datastore comprising a memory storing at least a set of tag information, tag management circuitry configured to receive, via a tag selection interface, an indication of selection of at least one tag corresponding to a set of tag information stored in a tag information datastore, access the tag information datastore to obtain the set of tag information, determine one or more applications associated with the set of tag information, and generate an instruction to each of the one or more applications based on the set of tag information, the instruction comprising data to cause a tagging component of each of the one or more applications to apply formatting to at least one component of a user interface to indicate content of the user interface associated with the set of tag information. The apparatus also includes tag/application interface circuitry configured to transmit the instruction to teach of the one or more applications. The at least one tag may include a plurality of tags and wherein two or more of the plurality of tags are associated with different applications.

The formatting applied to each of the different applications may include at least one consistent formatting element. The at least one consistent formatting element may be at least one of a color, a line quality, or a shading pattern. The one or more applications may be at least one of a picture archiving and communications system application or an electronic health records application. The tag management circuitry may also be configured to execute each of the one or more applications in response to receiving the indication of selection of the at least one tag. The set of tag information comprises application context information. The application context information may include at least one of an open file or a display setting.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of an apparatus for providing a messaging interface that may be specially configured in accordance with example embodiments of the present invention;

FIG. 2 is a block diagram of a dataflow between logical components of a computing device employing an application context tagging framework in accordance with example embodiments of the present invention;

FIG. 3 is an illustration of several applications employing context tags in accordance with example embodiments of the present invention;

FIG. 4 is a domain model diagram of relationships among logical elements of application context tags in accordance with example embodiments of the present invention; and

FIG. 5 is an illustration of an example of an interface for adding or editing context tag data to an application in accordance with example embodiments of the present invention;

FIG. 6 is a flow diagram depicting an example of a method for generating a tag in accordance with example embodiments of the present invention;

FIG. 7 is a flow diagram depicting an example of a method for storing a plurality of tags in a tag group in accordance with example embodiments of the present invention;

FIG. 8 is a flow diagram depicting an example of a method for loading a stored tag in an application interface in accordance with example embodiments of the present invention; and

FIG. 9 is a flow diagram depicting an example of a method for launching one or more applications and applying formatting to those application interfaces based on a selected tag group in accordance with example embodiments of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Introduction and Definitions

A method, apparatus and computer program product are provided in accordance with example embodiments of the present invention for a framework for communicating among applications to provide for context tagging within interfaces of the applications. As noted above, the inventors have identified that current systems for accessing information from a plurality of applications fail to provide for cross-application tagging of information in a manner that clearly identifies relevant information, correlations between information items, and tracking of the identified correlations and thoughts of the practitioner using the applications. In particular, the use of complex and information-dense interfaces in modern medical applications causes difficulties for practitioners in capturing their thought process in a manner suitable for review by other practitioners, using recorded processes as teaching aids, and otherwise storing and accessing context data related to identifying correlations associated with data presented across disparate application interfaces.

To address these problems, the inventors have developed an application tagging framework that incorporates particular logic associated with each individual application to communicate with a tag management component. The application tagging framework allows the practitioner to mark, highlight, or otherwise indicate particular elements of each application interface such that those elements are highlighted to a user viewing the interface. The application tagging framework further provides interfaces for configuring the display of the highlighted interface elements (e.g., selection of a highlight color, annotation symbol, border, or the like), and storing of narrative information associated with the tagged interface elements. The application tagging framework also provides for capturing of contextual data related to each application (e.g., configuration settings such as screen resolution, color depth, brightness and contrast settings, which file is open in the application and the like).

The application tagging framework also provides for selection of a previously stored tag or group of tags. Upon selection of the previously stored tag or group of tags via a tag selection interface, the portions of the application interfaces associated with the selected tag may be highlighted in the same manner as when the tags were stored. Selection of a particular tag via a tag selection interface may also include launching the one or more applications associated with the stored tags. In some embodiments, the applications may also be configured according to context information associated with the tags. Configuration of the applications according to the context information may include opening files, adjusting display settings, or the like.

The application tagging framework may include application specific logic included within or otherwise associated with each application for use in sending and receiving tag information from a tag management component. The application specific logic may include program code configured to alter the display characteristics of the application and otherwise affect the look and feel of the application interface to highlight, annotate, color code, or otherwise indicate the presence of an association between data displayed in the interface and a particular tag.

Communication between the application specific logic and the tag management component may be implemented according to an Application Programming Interface (API). Embodiments may define particular functions and methods for use with this API to enable communication of tag information for tag storage, communication of application context information for association with stored tags, receiving tag information for highlighting or indicating portions of the application display, or otherwise supporting implementation of the application tagging framework.

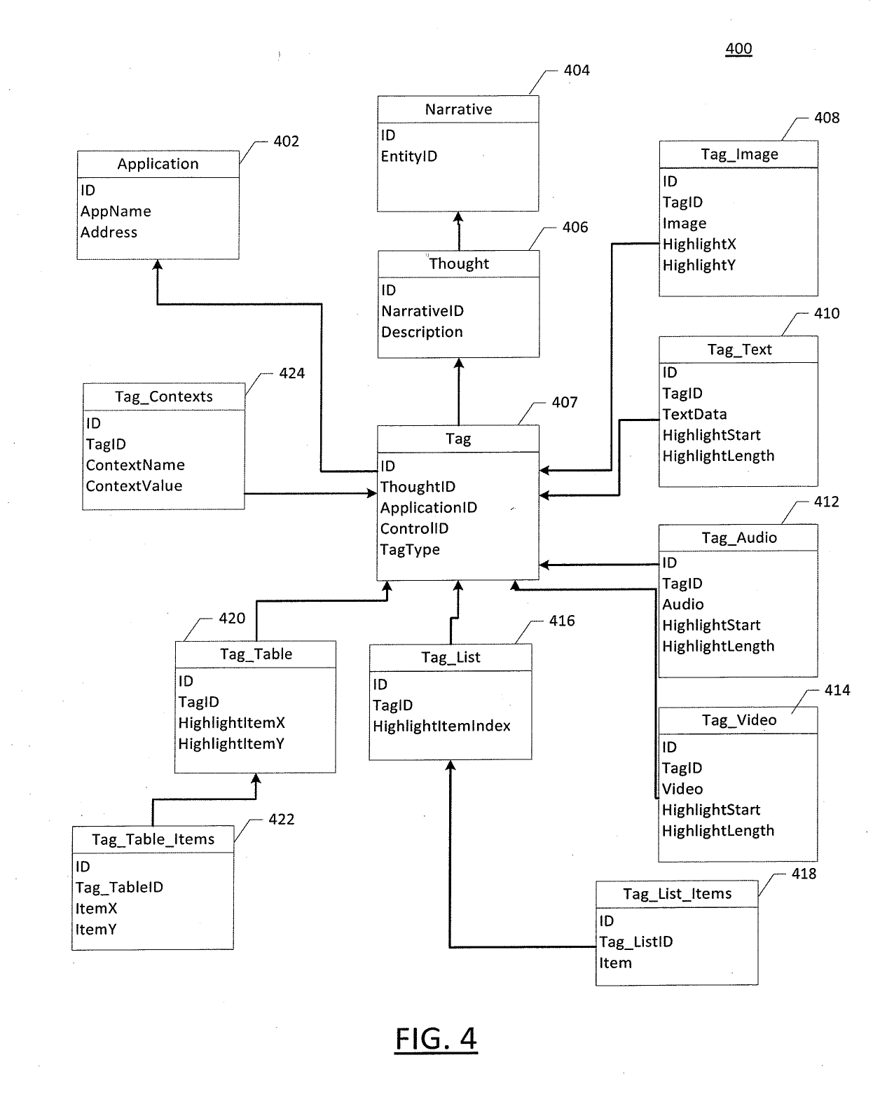

For the purposes of this disclosure, the term “tag information” refers to electronic data that is used to facilitate the storage and/or display of one or more application context tags used to annotate, highlight, or otherwise modify an application interface to indicate an association of a particular component of the interface with some information captured external to the particular interface. For example, tag information may include an association with a particular application, application context information, an association with a group of tags, an association with particular methods of annotation (e.g., an specific size, shape, color of annotation elements), an association with narrative information (e.g., text, videos, images, or recordings), or the like. Examples of types of tag information are described further below. For example, FIG. 4 depicts an example of a data structure used for capturing tag information, and it should be appreciated that any of the data types described with respect to FIG. 4 might be considered tag information within this definition.

Tag information may be presented and stored in a variety of formats. For example, in some embodiments raw information received from applications is converted into a structured data format (e.g., Extensible Markup Language (XML)), such that the tag information is generated upon receipt of the raw information. In some embodiments, tag information is generated in a particular format by the applications themselves and provided in the structured format prior to storage. As such, it should be appreciated that tag information may refer to both raw data and structured data, depending upon the context in which the tag information is described.

For the purposes of this disclosure, the term “application context information” refers to electronic data that indicates an operating state of a particular application at a particular time. The application context information should be understood to include application configuration settings (e.g., display settings, user preferences, or window configurations), and application state information (e.g., which image file is being viewed, which patient's medical records are opened, or which user is using the application).

### Example Client Apparatus

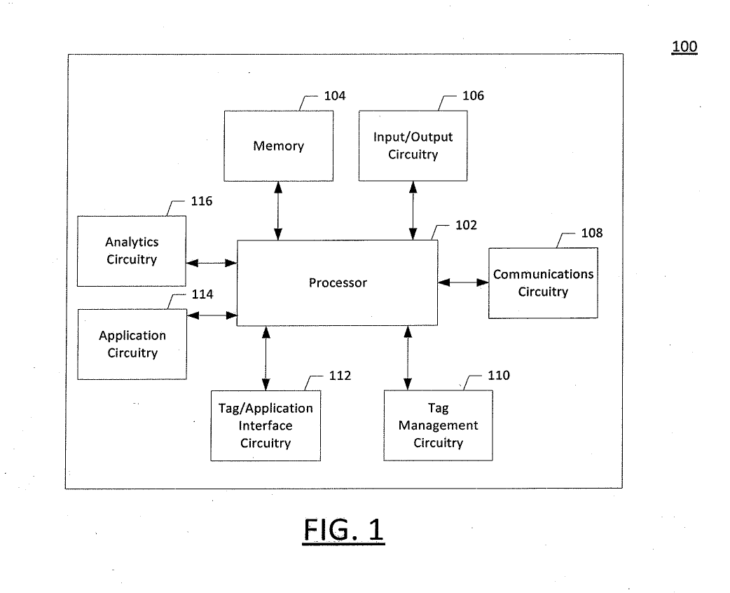

FIG. 1 illustrates a block diagram of an apparatus 100 in accordance with some example embodiments. The apparatus 100 may be any computing device capable of establishing an application tagging framework as described herein. For example, the apparatus 100 may be implemented as any device capable of implementing communications between one or more applications and a tag management component to annotate, overlay, or otherwise modify interfaces provided by the applications. The apparatus 100 may be implemented as a standalone or rack-mounted server, a desktop computer, a laptop computer, a personal digital assistant, a tablet computer, a netbook computer, a picture archiving and communication system (PACS) workstation, or the like. The apparatus 100 may be operable to cause the display of one or more application interfaces and to modify those interfaces to reflect stored tag information. The apparatus 100 may further provide various components and interfaces for management of tags, including creation, storage, and retrieval of tag information, along with launching of applications associated tags and configuring applications with application context information (e.g., adjusting configuration settings, opening files, etc.) stored within tags or otherwise associated with tags. Accordingly, it will be appreciated that the apparatus 100 may comprise an apparatus configured to implement and/or otherwise support implementation of various example embodiments described herein.

It should be noted that the components, devices or elements illustrated in and described with respect to FIG. 1 below may not be mandatory and thus some may be omitted in certain embodiments. Additionally, some embodiments may include further or different components, devices or elements beyond those illustrated in and described with respect to FIG. 1.

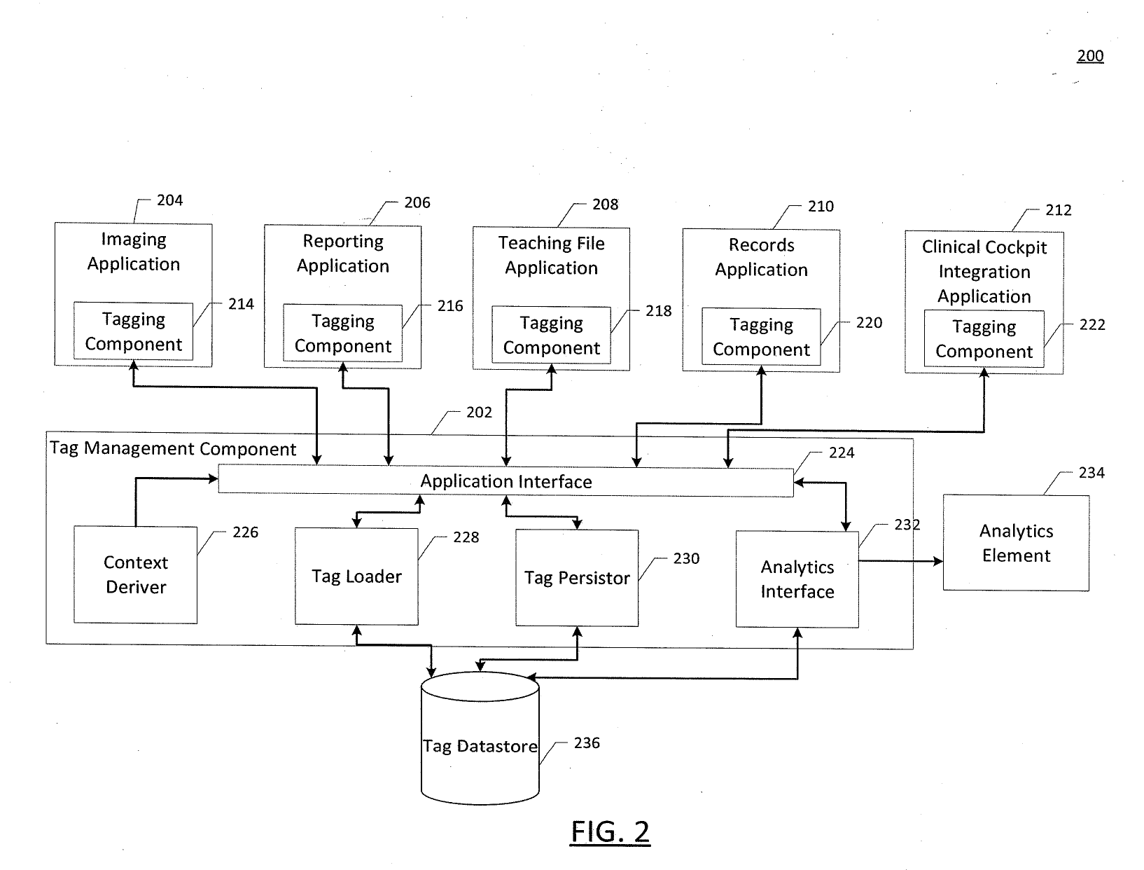

As illustrated in FIG. 1, an apparatus 100 may include a processor 102, a memory 104, input/output circuitry 106, communications circuitry 108, tag management circuitry 110, tag/application interface circuitry 112, application circuitry 114, and analytics circuitry 116. The apparatus 100 may be configured to execute the operations described below with respect to FIGS. 2-9. Although these components 102-116 are described with respect to functional limitations, it should be understood that the particular implementations necessarily include the use of particular hardware. It should also be understood that certain of these components 102-116 may include similar or common hardware. For example, two sets of circuitry may both leverage use of the same processor, network interface, storage medium, or the like to perform their associated functions, such that duplicate hardware is not required for each set of circuitry. The use of the term “circuitry” as used herein with respect to components of the apparatus should therefore be understood to include particular hardware configured to perform the functions associated with the particular circuitry as described herein.

The term “circuitry” should be understood broadly to include hardware and, in some embodiments, software for configuring the hardware. For example, in some embodiments, “circuitry” may include processing circuitry, storage media, network interfaces, input/output devices, and the like. In some embodiments, other elements of the apparatus 100 may provide or supplement the functionality of particular circuitry. For example, the processor 102 may provide processing functionality, the memory 104 may provide storage functionality, the communications circuitry 108 may provide network interface functionality, and the like.

In some embodiments, the processor 102 (and/or co-processor or any other processing circuitry assisting or otherwise associated with the processor) may be in communication with the memory 104 via a bus for passing information among components of the apparatus. The memory 104 may be non-transitory and may include, for example, one or more volatile and/or non-volatile memories. In other words, for example, the memory may be an electronic storage device (e.g., a computer readable storage medium). The memory 104 may be configured to store information, data, content, applications, instructions, or the like, for enabling the apparatus to carry out various functions in accordance with example embodiments of the present invention.

The processor 102 may be embodied in a number of different ways and may, for example, include one or more processing devices configured to perform independently. Additionally or alternatively, the processor may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In an example embodiment, the processor 102 may be configured to execute instructions stored in the memory 104 or otherwise accessible to the processor. Alternatively or additionally, the processor may be configured to execute hard-coded functionality. As such, whether configured by hardware or software methods, or by a combination thereof, the processor may represent an entity (e.g., physically embodied in circuitry) capable of performing operations according to an embodiment of the present invention while configured accordingly.

Alternatively, as another example, when the processor is embodied as an executor of software instructions, the instructions may specifically configure the processor to perform the algorithms and/or operations described herein when the instructions are executed.

In some embodiments, the apparatus 100 may include input/output circuitry 106 that may, in turn, be in communication with processor 102 to provide output to the user and, in some embodiments, to receive an indication of a user input. The input/output circuitry 106 may comprise a user interface and may include a display and may comprise a web user interface, a mobile application, a client device, a kiosk, or the like. In some embodiments, the input/output circuitry 106 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 104, and/or the like).

The communications circuitry 108 may be any means such as a device or circuitry embodied in either hardware or a combination of hardware and software that is configured to receive and/or transmit data from/to a network and/or any other device, circuitry, or module in communication with the apparatus 100. In this regard, the communications circuitry 108 may include, for example, a network interface for enabling communications with a wired or wireless communication network. For example, the communications circuitry 108 may include one or more network interface cards, antennae, buses, switches, routers, modems, and supporting hardware and/or software, or any other device suitable for enabling communications via a network. Additionally or alternatively, the communication interface may include the circuitry for interacting with the antenna(s) to cause transmission of signals via the antenna(s) or to handle receipt of signals received via the antenna(s).

The tag management circuitry 110 includes hardware configured to create, store, and access one or more tags for use in an application tagging framework in accordance with embodiments of the present invention. The tag management circuitry 110 may be in communication with one or more applications (e.g., as provided by the application circuitry 114) to facilitate display of information associated with tags within an interface associated with the applications. The tag management circuitry 110 may also include an independent interface for selecting a tag or group of tags, for annotating or editing tag information associated with a tag or group of tags, or otherwise viewing, accessing, editing, or deleting tags or a group of tags. It should also be appreciated that, in some embodiments, the tag management circuitry 110 may include a separate processor, specially configured field programmable gate array (FPGA), or application specific interface circuit (ASIC) for managing tags and groups of tags. The tag management circuitry 110 is therefore implemented using hardware components of the apparatus configured by either hardware or software for implementing these planned functions.

The tag/application interface circuitry 112 includes hardware configured to manage communication between a tag management component (e.g., a tag management application implemented by the tag management circuitry 110) and one or more applications executed by the apparatus. The tag/application interface circuitry 112 may include one or more buses, network elements, application programming interfaces, shared memories, or other communication mechanisms for providing tag information to particular applications, configuring those particular applications according to the tag information, and notifying the particular applications how to highlight or otherwise annotate their respective interfaces based on tag information. The tag/application interface circuitry 112 may also be configured to receive tag information from applications, including but not limited to tag locations within the application interface, narrative information associated with the tag, application context information associated with the application, and the like. In some embodiments, the tag management circuitry 112 may format incoming data received from applications into a markup language format, such as XML. The tag management circuitry 112 may further maintain a message infrastructure to enable communications between applications and the tag management component (e.g., message queues, routing of data, and the like). Communication among the applications and any tag management components may be performed using processing circuitry, such as the processor 102, and a network interface, such as the communications circuitry 108. It should also be appreciated that, in some embodiments, the tag management circuitry 112 may include a separate processor, specially configured field programmable gate array (FPGA), or application specific interface circuit (ASIC) to provide for communication in this manner. The tag management circuitry 112 is therefore implemented using hardware components of the apparatus configured by either hardware or software for implementing these planned functions.

The application circuitry 114 includes hardware configured to perform a particular function using an interface that is capable of being annotated and/or overlaid in accordance with information, such as tag information, received from the tag/application interface circuitry 112. It should be appreciated that, while the instant examples are generally described with respect to medical applications, embodiments could be used in other technical fields to facilitate the annotation and display of information across disparate application interfaces. The application circuitry 114 may be configured to provide management of patient electronic health records, management of a hospital admission system, management of a medical picture archive and communications system (PACS), or the like. The application circuitry 114 may communicate with a tag management component and other applications executing with the application tagging framework via the tag/application interface circuitry 112. It should also be appreciated that, in some embodiments, the application circuitry 114 may include a separate processor, specially configured field programmable gate array (FPGA), or application specific interface circuit (ASIC) to generate the context data. The application circuitry 114 is therefore implemented using hardware components of the apparatus configured by either hardware or software for implementing these planned functions.

The analytics circuitry 116 includes hardware configured to generate analytic data through analysis of stored tag information. By storing tag information, embodiments of the application tagging framework may amass a large amount of data related to the functions performed by applications executing on the apparatus 100 (e.g., medical applications). The analytics circuitry may analyze and process this tag information to identify patterns, correlations, and associations between stored tag information and other data sets. The analytics circuitry may note that a particular term that appears in tag narrative is correlated with annotation of one or more particular applications. For example, the term “colon cancer” in a narrative may be identified as having a strong correlation with annotation of a CT scan image and a set of lab test results. In some embodiments, terms may also be correlated with particular application context information (e.g., correlating “colon cancer” with a CT scan of a patient's abdomen and a particular type of lab test). Analytic information may be generated through regression analysis and/or various other techniques for identifying correlations between data sets. The analytics circuitry 116 may, in some embodiments, leverage fields of a data structure storing the tag information or a series of markup language tags associated with the tag information to categorize and evaluate the tag information for correlations. The analytics circuitry 116 may perform these functions through the use of processing circuitry, such as the processor 102. It should also be appreciated that, in some embodiments, the analytics circuitry 116 may include a separate processor, specially configured field programmable gate array (FPGA), or application specific interface circuit (ASIC) to generate the context data. The analytics circuitry 116 is therefore implemented using hardware components of the apparatus configured by either hardware or software for implementing these planned functions.

As will be appreciated, any such computer program instructions and/or other type of code may be loaded onto a computer, processor or other programmable apparatus's circuitry to produce a machine, such that the computer, processor other programmable circuitry that execute the code on the machine create the means for implementing various functions, including those described herein.

As described above and as will be appreciated based on this disclosure, embodiments of the present invention may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

Having now described an apparatus configured to implement and/or support implementation of various example embodiments, features of several example embodiments will now be described. It will be appreciated that the following features are non-limiting examples of features provided by some example embodiments. Further, it will be appreciated that embodiments are contemplated within the scope of disclosure that implement various subsets or combinations of the features further described herein. Accordingly, it will be appreciated that some example embodiments may omit one or more of the following features and/or implement variations of one or more of the following features.

Exemplary Application Tagging Framework Data Flow

FIG. 2 is an illustration of an example data flow 200 for providing an application tagging framework in accordance with example embodiments of the present invention. The data flow 200 illustrates communications between and among components of an application tagging framework. The application tagging framework may be implemented using a tag management component 202 in communication with one or more applications 204-212. The tag management component 202 may store tag information within a tag datastore 236. The tag management component 202 may also communicate with an analytics element 234 for the purpose of deriving analytics from stored tag information. The data flow 200 may be implemented by components of an apparatus, such as the apparatus 100 described above with respect to FIG. 1.

The tag management component 202 may include an application interface 224 in communication with one or more of a context deriver 226, a tag loader 228, a tag persistor 230, and an analytics interface 232. The tag management component 202 may be implemented by, for example, tag management circuitry as described above with respect to FIG. 1.

The tag management component 202 may be operable to control storage of tag information, communication of tag information to the applications 204-212 for use in annotating, highlighting, or otherwise being displayed within interfaces provided by the applications 204-212, receiving of context data from the applications 204-212 for storage along with tag information, and any other actions related to generating, storing, retrieving, displaying, accessing, or editing tag information.

The application interface 224 may operate to send and receive data to and from the applications 204-212. The application interface 224 may implement an API for receiving data from and providing data to the applications 204-212. In some embodiments, the application interface 224 may include one or more threads, queues, or callback functions that are operable to receive data from the applications 204-212. The application interface 224 may also include various buses, network interfaces, shared memories, and other mechanisms for communicating with the applications 204-212. In some embodiments, the application interface 224 interprets messages and other data received from the applications 204-212 and routes that data to other elements of the tag management component 202. For example, the application interface 224 may route incoming data messages from the applications 204 to a particular element of the tag management component 202 based on a message type of the received data message. As such, the application interface 224 may communicate with both the applications 204-212 and one or more of the context deriver 226, the tag loader 228, the tag persistor 220, and the analytics interface 232. The application interface 224 may be implemented as tag/application interface circuitry as described above with respect to FIG. 1.

The context deriver 226 may operate to receive context data from an application and generate tag information in an application-agnostic format that may be saved or used by other elements of the tag management component 202. To this end, the context deriver 226 may include logic configured to interpret context data from particular applications and to format that received context data into the application-agnostic format. For example, the context deriver 226 may include the ability to perform natural language processing on received text data, perform Internet or medical dictionary searches based on received text data, perform speech-to-text analysis on recorded audio data, detect objects within portions of a tagged image using image analysis techniques, process image metadata (e.g., Digital Imaging and Communications in Medicine (DICOM) image headers), or the like. Different processing techniques may be employed based on the particular application. For example, a speech-to-text process might be performed on an audio recording, while an image analysis might be performed on a received image.

As specific examples, the context deriver 226 may be operable to identify that a received image is a picture of a tumor based on image analysis techniques, to determine that a patient is over 50 years old based on analysis of image metadata identifying the patient, to use natural language planning techniques to note high creatinine levels and an abnormal white blood cell count from a lab result, or the like. The context deriver 226 may also aggregate data from multiple tags within a tag group such that, using the above example, a context for a group of tags from the above example might indicate that a 50 year old patient has a tumor, high creatinine levels, and an abnormal white blood cell count if each of the above sets of data were tagged for a single tag group. Tag information derived by the context deriver 226 may be stored in the tag datastore 236.

The tag loader 228 operates to retrieve tag information stored in the tag datastore and to communicate to the appropriate applications using the application interface 224. To perform these functions, the tag loader 228 may obtain tag information associated with a particular tag or group of tags from the tag datastore 236. The tag loader 228 may identify particular associated applications from the retrieved tag information, and generate messages for each of the associated applications with data sufficient to annotate, modify, or otherwise alter the look and feel of an interface for the application to note the portions of the application interface associated with the tag information. The tag loader 228 may send messages communicating such information to the applications via the application interface 224. The tag loader 228 may also provide a user interface element for selecting a particular tag or group of tags to be loaded. For example, the tag loader 228 may provide a search interface, a drop-down selection box, or various other interfaces for listing, selecting, and indexing tags stored in the tag datastore 236.

The tag persistor 230 operates to capture and save tag information to the tag datastore 236. Once tag information is saved by the tag persistor 230, the tag information may be used by various other elements of the tag management component 202. The tag persistor 230 may receive various tag information and/or application context data from the applications 204-212. In some embodiments, the tag persistor 230 may automatically extract and/or derive information such as a tag narrative from items that are tagged and/or an application context. For example, a tag narrative may be automatically set to the encounter identifier for a particular patient medical record number (MRN). Consequently, without user interaction, the tag persistor 230 may generate a complete narrative for a set of tags for that patient encounter over the course of the patient's treatment. In some embodiments, the tag persistor also implements a separate interface for providing tag data separately from the applications 204-212. For example, the tag persistor 230 may implement a window for selecting a tag name, providing a tag narrative, noting applications associated with the tag, or the like. In some embodiments, the tag persistor 230 may communicate with an interface provided by the tag loader 228 for selecting tags. Tag information for selected tags maybe displayed within the tag persistor 230 to allow for editing, modification, or deletion of such tags or tag information. In some embodiments, a single interface is provided for both the tag loader 228 and the tag persistor 230, such that the interface acts as a single application with the function of providing a graphical user interface that allows users to select tags, view tag information, create tags, store or edit tag information, or the like. Details of a particular structure for storage of tag information are described further below with respect to FIG. 4.

The tag persistor 230 may also store data related to versioning for tag information related to the application associated with the tag. In this manner, the tag persistor 230 may provide a mechanism for identification of errors in loading of a tag, a mismatch between the tag and an application context, whether the application supports the particular tagged interface control, or the like. Such versioning information may include a version of the tag itself, unique identifiers generated for the tags, a timestamp at which the tag was captured, a checksum, or the like.

The tag datastore 236 includes a data structure for storing tag information. An example of data elements that may make up such a data structure is described further below with respect to FIG. 4. The tag datastore 236 may be indexed by individual tags, by groupings of tags, or by any other method that facilitates storage and retrieval of tag information. The tag datastore 236 may be implemented as a relational database, a flat file, in a system memory, or via any other storage technique.

The analytics interface 232 provides a mechanism for an analytics element 234 to access the tag datastore 236 for providing analytics. The analytics interface 232 and/or analytics element 234 may be implemented via analytics circuitry as described above with respect to FIG. 1. In the present example, the analytics element 234 is depicted as a separate structure from the tag management component 202, though it should be appreciated that in some embodiments the analytics element 234 may be implemented as part of the tag management component 202. In such cases, the analytics interface 232 may not be necessary.

The analytics interface 232 may provide an interface for retrieval of data from the tag datastore by one or more external elements, such as the analytics element 234. The analytics interface 232 may implement queries or other mechanisms for selecting and retrieving particular sets of tag information from the tag datastore 236. The analytics element 234 may analyze the tag information and identify correlations between particular terms and elements. The analytics element 234 may also provide certain quality control functions, such as identification and notification of possible analysis errors (e.g., where tagged elements appear to be totally unrelated to one another or to a defined diagnosis), measurement of metrics by comparing against objective evaluation criteria (e.g., a particular diagnosis is expected to be supported by particular types of tagged data), and various other tasks related to evaluation of tag information.

As noted above, the tag management component 202 may interface with a variety of different applications. As specific, non-limiting examples, the tag management component 202 may interact with an imaging application 204 (e.g., a PACS workstation), a reporting application 206, a teaching file application 208 (e.g., an application designed to capture and play back user input for teaching purposes), a records application 210 (e.g., an electronic health records application for accessing patient medical histories or lab results), and a clinical cockpit integration application 212 (e.g., a practitioner “dashboard” aggregating data from multiple sources).

Each of these applications 202-212 may implement its own respective logic for interaction with the tag management component. This logic is represented as a tagging component 214-222 associated with each application, respectively. It should be appreciated that different applications may implement their respective tagging components in different manners. For example, an imaging application tagging component may include features for highlighting or annotating particular portions of a displayed image, while an audio recording playback tagging component may include features for selecting a portion of the audio recording (e.g., highlighting timestamps of a recording selection bar interface), and an electronic health records application tagging component may be configured to select particular text from a patient health record. Further example applications may include a web browser implementing tags for selection or a particular uniform resource locator (URL), selection of a particular set of text located at a particular URL, selection of particular images or a portion of an image located at a particular URL, or selection of a particular video or portion of a video located at a particular URL. Additional example applications may include video playback applications that support selection of an entire video file, selection of a particular point in time or a range of time values of a video (e.g., including both the video frame and associated audio), or selection of a particular portion of a particular frame of a selected video. In some embodiments implementation of the tagging component for each application may be left up to the developers of the particular application, while in other embodiments certain standardized features, functions, or APIs may be required in the implementation of the tagging component.

It should be appreciated that, as a general rule, application tagging components may be operable to provide some sort of annotation, display, audio cue, or other indication of which portion of content provided by the respective application is associated with a selected tag. The tagging components 214-222 may also include interfaces for selecting such content. For example, the tagging components 214-222 may provide “toolbar” style interfaces that allow for a variety of tools used for selecting, drawing, highlighting, or otherwise noting content within the application to be associated with a tag. The tagging components 214-222 may also provide an interface for inputting text data to be associated with the tag, an interface for selecting a particular tag group for association with a newly created tag, or the like.

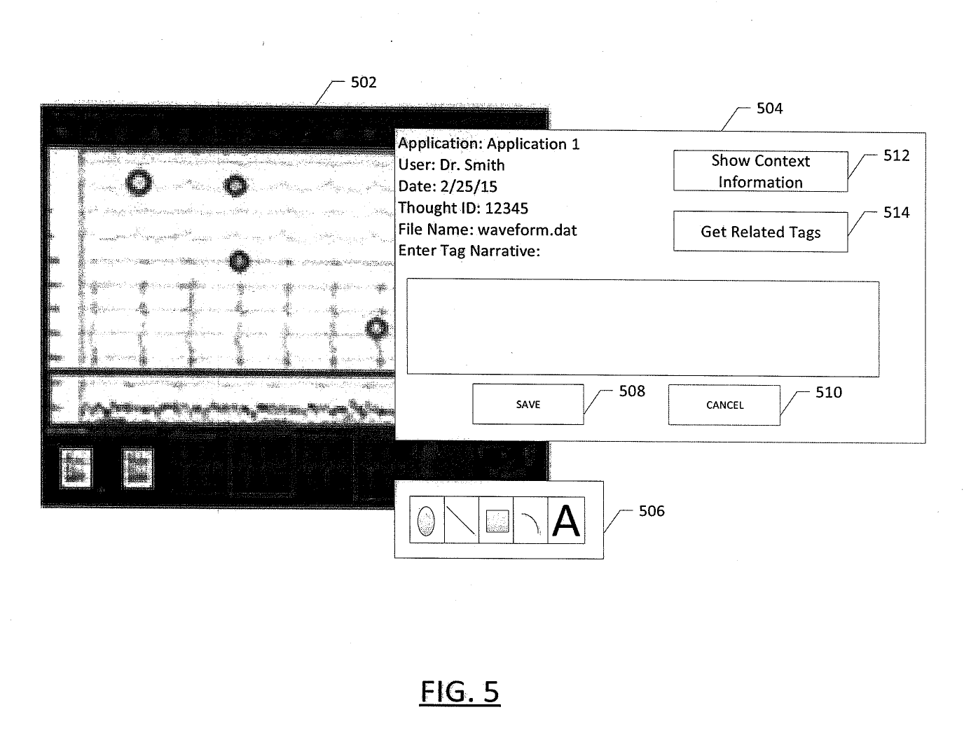

The tagging components 214-222 may contain internal logic and/or an external interface for assistance with selection of the particular interface elements to be tagged during a tagging operation. For example, an application may have an image tag, and the image data may be passed into the application interface 224 to be persisted to storage and for further context processing and analysis. Alternatively, the application may have an image tagged in a user interface, and the tagging component within the application may analyze the image and only pass the results of the analysis (e.g., text information not including the tagged image itself) to the application interface 224. An example interface for implementing a user interface provided by a tagging component is described further below with respect to FIG. 5.

Upon selection of a tag or tag group within an interface provided by the tag management component 202, the tag loader 228 may obtain tag information associated with the selected tag or tag group. The tag loader 228 may use this information to determine which applications are associated with the selected tag or tag group, and any relevant tag information for display within those applications. The tag loader 228 may provide such information to the application interface 224, which messages each of the applications associated with the selected tag or tag group to provide the relevant tag information to those applications. Upon receiving the tag information, logic within the tagging component 214-222 facilitates an alteration of the interface of the application to note the tagged information. For example, the tag information may include coordinates for a particular symbol or shape within an image, a size of the symbol or shape, a color of the symbol or shape, and the like. The tagging component 214-222 may receive this information and display the shape or symbol accordingly. As another example, the tag information may indicate a particular data field or text within a data field to be highlighted (e.g., a certain lab result). A tagging component of an electronic health records application may identify the particular data field or text from the tag information and apply a particular highlight color to the particular data field or text. The tag loader 228 may also provide error checking and/or visualization indicators in the event the tag loader 228 and/or the tagging component 214-222 is unable to load the tag, such as in the case of a version mismatch in the application between when the tag was captured and when the tag was loaded (e.g., where a newer version of the application rearranges an interface or removes an interface control associated with the tag).

It should also be appreciated that a given group of tags may include tags for multiple applications. For example, each tag group may constitute a “thought,” representing each of the data points employed by a practitioner to come to a particular conclusion (e.g., analysis of a set of test results, a medical diagnosis, or the like). The practitioner may thus highlight content of each application that was used to arrive at the conclusion associated with the “thought.” Upon selection of the “thought” at a later time, each of the sets of content associated with that thought may be highlighted or otherwise indicated within the respective application interfaces.

Exemplary Tagging Methodologies

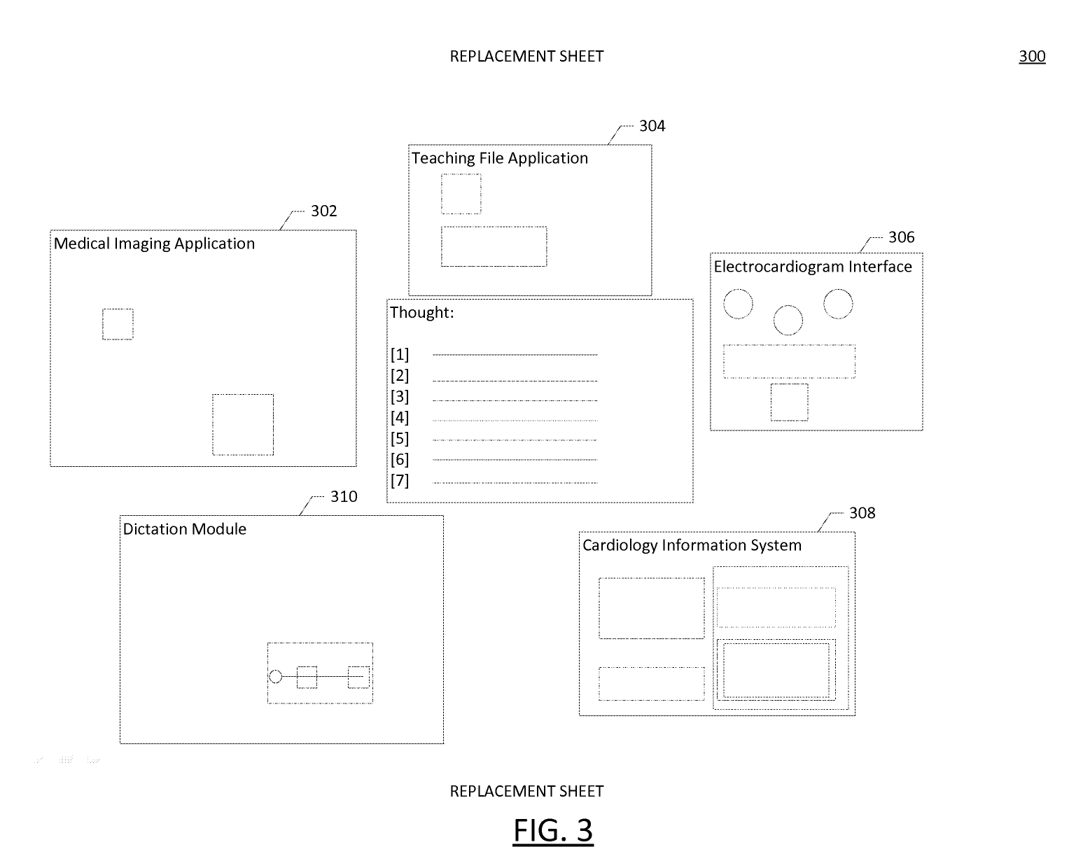

FIG. 3 illustrates tagging methodologies for different applications. As noted above, different applications may employ different methods for highlighting particular sets of content. For example, a medical imaging application 302 may provide the ability to select or highlight particular portions of a medical image, a subset of a series of images, or the like. A teaching file application 304 may provide playback and instruction to practitioners as to how to conduct a particular study, and the teaching file application 304 may allow for tagging of an image or text findings, community comments for public web-based applications (e.g., mypacs.net), and other sort of learning data that may be employed for such applications. An electrocardiogram or other waveform viewing interface such as the interface 306, may allow for highlighting or other indication of particular axes or points on a waveform. A cardiology information system 308 may allow for tagging of particular text or data in fields or in report data. A dictation module 310 may allow tagging of an entire file or particular parts/sections of the file along with any demographic/clinical data depicted.

Different tags or tag groupings may be highlighted in particular ways, such that tags within a group have one or more consistent formatting elements. For example, some embodiments may use a different color for each group of tags. Other embodiments may use particular line qualities (e.g., dotted lines, dashed lines), shading, or other techniques to differentiate between groups of tags. It should be appreciated that some embodiments may provide for selection and display of multiple tags or groups of tags at a single time, as well. Tags may be differentiated from one another based on similar display characteristics. It should also be appreciated that in some alternative embodiments, particular interface components may be highlighted, rather than the content itself. For example, in the case of an audio recording, an audio time selector bar may be annotated with marks indicating the beginning and ending of a portion of the audio recording in accordance with timestamps of the beginning and ending of tagged portions of the audio recording.

### Exemplary Tag Domain Model

FIG. 4 illustrates an exemplary tag domain model 400 noting one possible structure of a set of tag information in accordance with some embodiments of the present invention. The tag domain model 400 illustrates logical associations between particular data types for use in an application tagging framework. In particular, the domain model 400 uses arrows to illustrate various one-to-many and many-to-one relationships. In the present example, elements with a one-to-many relationship are denoted by a connecting line starting from the element with the “many” characteristic, such that arrows from each element points to a “parent” element, where each element has only one parent. For example, a thought element 406 may be associated with many tag elements 407, and a tag context 424 may be associated with one tag element 407. It should be appreciated that each element of the domain model may be associated with a unique identifier (e.g., the “ID” value), and that each particular type of element may include one or more unique data elements associated with that element.

In the present example, the thought element 406 may be used to refer to one or more tag elements 407 associated with an overall narrative 404. For example, a user may select a particular thought via an interface and be presented with other thoughts within the same narrative 404 accompanying the thought element 406 and portions of application interfaces associated with each tag associated with the selected thought may be highlighted. In this manner, a user may be presented with a highlight of the appropriate portions of each application interface the practitioner employed when coming to the conclusion expressed in the thoughts of the narrative 404. In this manner, the overall narrative 404 may function to join together many different distinct thoughts. The overall narrative 404 therefore functions as an overall summary for some particular concept or entity (e.g., a patient's encounter that could span weeks across different health institutions and/or physicians) that has multiple lines/groups of thinking contributing over the lifetime of the overall narrative 404.

Each tag element 407 may be associated with a particular application element 402, indicating the application interface to which the tag element 407 is associated. The tag element 407 may also be associated with one or more tag context elements 424. The tag context elements 424 may note particular configuration settings for the application, files opened by the application, or other contextual data related to displaying the tag information within the appropriate application. When a thought element 406 is selected (e.g., by an interface for viewing or accessing tagged information), the tag contexts 424 connected to each of the tags of the thought may be coalesced into a meaningful/user friendly manner. In this regard, a user interface that displays the thought element 406 and associated tag context elements 424 and other tag information may mark and organize information based on a variety of data. For example, a selection interface may color code related thought elements, alter the display or location of application windows to ensure that each tagged interface control is visible, or the like.

Different types of tag elements 407 may also be associated with particular tag metadata. For example, a tag of an image may be associated with a Tag_Image data element 408, indicating a particular image and position within the image to highlight.

A tag associated with a text field may be associated with Tag_Text data element 410 that includes an indication of a particular text field, along with where to begin highlighting of the text field and a length of the highlight.

A tag associated with an audio recording may be associated with a Tag_Audio data element 412 which indicates the particular audio file, the start of the highlighted audio playback time, and the length of the highlight.

A tag associated with a video recording may be associated with a Tag_Video data element 414 which indicates the video, the start of the highlighted video playback time, and a length of the highlight. An exemplary Tag_Video data element 414 may also include particular portions of particular frames of a video for highlighting.

A tag associated with a list of items may be associated with a Tag_List data element 416, indicating which items to highlight from the list. The Tag_List data element 416 may further be associated with one or more Tag_List Items data elements 418, which include separate highlighting for particular items of the list.

A tag associated with a table of items may be associated with a Tag_Table data element 420, which indicates which items to highlight within a table by giving x and y coordinates. The Tag_Table data element 420 may be further associated with one or more Tag_Table Items data elements 422 which indicate how highlighting should be applied to particular items within the table.

It should be appreciated that the instant domain model 400 is only one example of a domain model to support embodiments of the present invention. For example, an alternative domain model may have tag information correspond to one or more basic positional items that merely indicate a particular position within a relevant file or object (e.g., a timestamp of an audio recording, pixel coordinates of an image, an index in an array of patient medical records). In such an alternative domain model, a given set of tag information may not be “strongly typed” or have an explicit meaning outside of the associated application, and instead such meaning may be inferred from the recorded data and/or through the use and/or context of the data associated with the application associated with the tag at the time of recording. For example, a given set of tag information associated with a video and a playback time indicating an associated range of the video, while another set of tag information may include the video file, a playback time, and a particular screen coordinate associated with the video at that playback time. Yet another set of tag information may use the same type of position information but in association with an audio file, such that the position information is associated with a playback position in the audio file instead of the video file. Accordingly, while tags may include similar types of information, the meaning of such information in the context of the associated application may be different. In some embodiments, tags that employ such a positional component may be associated with a generic tag data type and a set of position information, and each application may derive a separate interpretation from the position information. Such a generic tag definition may also allow for association with a variety of particular tag attributes dependent upon the needs of particular applications.

It should be appreciated that, to provide the interface modification capabilities of embodiments of the present invention, one or more of the particular applications or an application interface may interpret data stored according to the exemplary domain model. For example, one or more of logic within the application and an application interface may be operable to translate data provided according to the domain model 400 into particular pixels to be highlighted within an interface provided by the application. It should also be appreciated that, in some embodiments, providing an indication of the tagged portion of an interface is provided by an application that provides an overlay on the appropriate interface, such that the application interface is not directly modified, but rather highlighting or annotation is provided on a separate screen layer from the application interface. To that end, some embodiments may interact with a display device, display driver, graphics processing unit, or other component of an apparatus executing an application to provide such functionality.

### Exemplary Tagging Interface

FIG. 5 illustrates an example of an interface for applying application tags using an application tagging framework in accordance with embodiments of the present invention. As described above, applications may include a tagging component that allows for creation of a tag within an application interface 502. Selection of a particular interface control within the application interface may open a data entry window 504 for entry of tag information and a toolbar 506 containing controls to be used for highlighting portions of the application interface 502. The data entry window 504 may include information related to the application, the user, a date, an identifier, a file name opened by the application, and a text box for entry of a narrative. The toolbar 506 may include a variety of interface controls for annotating the application interface 502. Upon selection of an interface control and annotation of the application interface 502, tag information relating to the size, shape, location, color, and the like of the selected annotation control may be stored as tag information. The data entry window 504 may include a save control 508 and a cancel control 510. Upon selection of the save control 508, tag information entered into the data entry window 504 and the tag information associated with the annotations applied to the application interface 502 may be stored and propagated to a tag datastore, such as described above with respect to FIG. 2. In some embodiments, the data entry window 504 may also include a drop-down menu (not shown) for selecting a particular “thought” or tag group to which the newly created tag should be associated. Although the instant interface 500 describes a mechanism for direct entry of tag information, it should be appreciated that embodiments may also provide for programmatic and/or automatic derivation of tag information. For example, embodiments may derive patient identification information (e.g., a patient MRN) from an application context and include such information as tag information. Embodiments may include a “show context information” control 512 that allows for capture and/or display of context information associated with a particular application or applications. For example, the control 512 may display all application context information being captured from the application 502 that will be associated with a newly generated tag.

Embodiments may also include a “get related tags” control 514. The control 514 may be utilized to identify, automatically or manually, similar tags, other tags associated with the same narrative, or the like. In some embodiments, these other tags may be provided for association with a tag to be newly generated by the interface, or the interface may be prepopulated with information from similar tags to simplify and streamline the tag generation process.

It should also be appreciated that some embodiments may implement a tag data entry interface that is separate and distinct from logic included in each particular application. For example, a standalone application may provide a data entry window that communicates with tagging logic present within each appropriately configured application executing on the same apparatus. As annotations are performed within each respective application by the application's tagging logic, the standalone application may receive tag information from the applications and provide an interface for viewing and editing that tag information. In some embodiments this standalone application may also provide a “dashboard” type interface that highlights all of the applications available for performing tag generation on the apparatus, whether those applications are executing, which tags or tag groups are associated with those applications, or the like.

### Example Processes for Providing an Application Tagging Framework

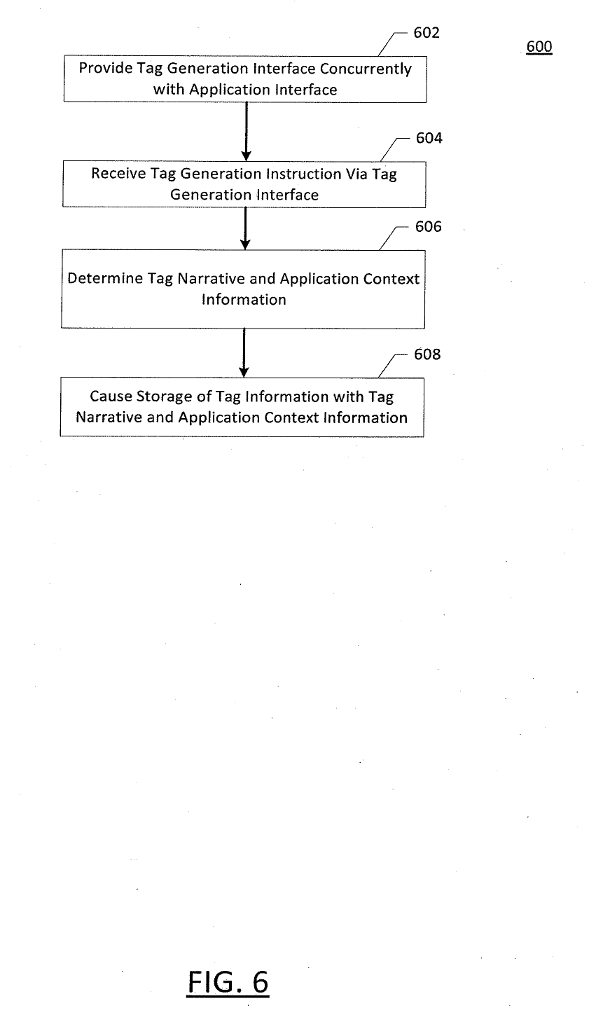

FIG. 6 is a flow diagram illustrating an example of a process 600 for storing tag information in accordance with example embodiments of the present invention. The process 600 is operable to capture data during a tagging operation employed with an application executing on an apparatus that implements an application tagging framework in accordance with some embodiments of the present invention. Embodiments of the process 600 may be performed by an apparatus, such as the apparatus 100 described with respect to FIG. 1, and as part of an application tagging framework depicted with respect to FIG. 2.

At action 602, a tag generation interface is provided concurrently with an application interface. As noted above with respect to FIGS. 1-5, the tag generation interface may be provided as part of the application logic (e.g., as a tagging interface implemented by the application itself) or as a standalone application in communication with the application (e.g., as a separate process that may send and/or receive data to and from one or more applications but otherwise executes independently). The tag generation interface 602 may include one or more fields, toolbars, and the like for highlighting, annotating, or selecting portions of the application interface and for entering, selecting, and viewing data to be associated with a newly generated tag and/or stored as tag information.

At action 604, a tag generation instruction is received via the tag generation interface. The tag generation instruction may include selection of an interface control, such as a “submit” or “save” control provided within the tag generation interface. The tag generation instruction may be sent only in response to the interface determining that a certain minimum set of data has been entered. For example, the interface may require entry of a narrative, selection of a tag group or “thought”, highlighting or other annotation of a portion of an application interface, or a variety of other criteria before providing the tag generation instruction. The particular criteria required to cause the tag generation instruction to be sent may vary from one application to another. For example, a medical imaging application may require selection of a portion of an image, while an audio playback application may require selection of a start and end portion of an audio recording.

At action 606, a tag narrative and application context information are determined. The tag narrative may indicate the conclusion or thought that the user wishes to associate with the tagged portion of the application interface. It should be appreciated that not all newly created tags may include narratives, and in some embodiments the narrative may be provided prior to causing the tag generation instruction to be sent. The application context information may be captured at the time the tag generation instruction is sent, or the application context information may be captured prior to receiving the tag generation instruction. In some embodiments, an editing interface for altering captured application context information may be provided. In yet further embodiments, the application context information may be provided via a tagging API utilized by the application. As noted above, the tag narrative and other tag information may be determined manually, by capturing information provided directly to a tag generation interface, or programmatically from application context information, from analysis of tagged elements of the application interface, or the like.

At action 608, tag information, the narrative, and the application context information are stored, such as within a tag datastore as described above with respect to FIG. 2. Once the tag information is stored, it may be accessed at a later time to recreate the annotations, application context, and any other data provided during the tagging process to assist a viewer with understanding the conclusion arrived from a thought within a narrative.

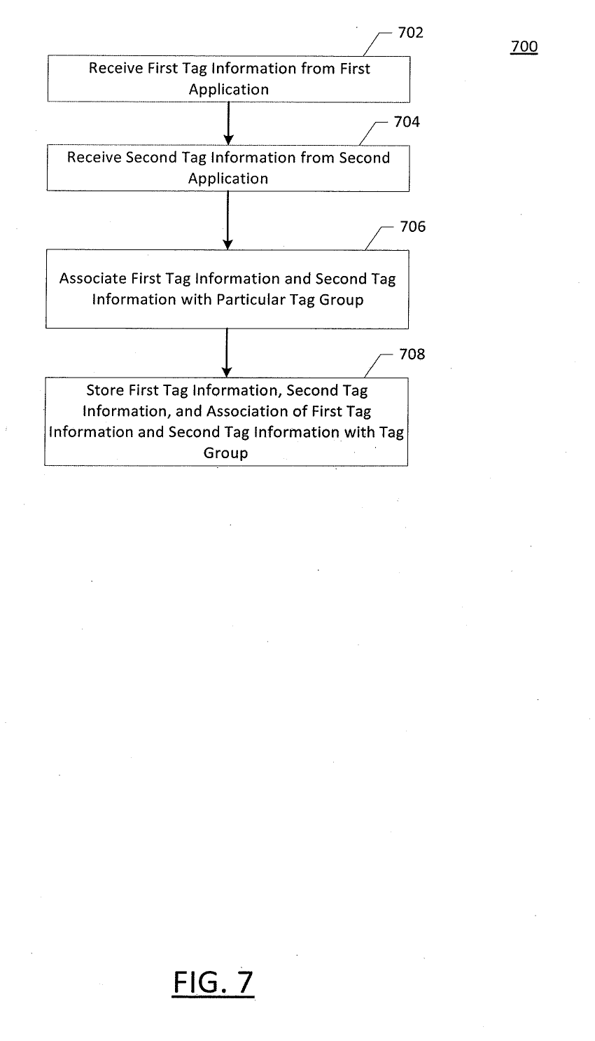

FIG. 7 is a flow diagram illustrating a process 700 for establishing a tag group in accordance with embodiments of the present invention. As noted above with respect to FIGS. 1-6, a tag may be assigned to a group of tags (e.g., a thought) for a particular conclusion which, in turn, are associated with a single narrative related to each of the tags, reflecting a group of conclusions at which the user arrived based on the tagged information. It should be appreciated that this particular use of the thought and narrative fields may be optional, and that embodiments may also link tags together in different ways or for different purposes other than to highlight a particular conclusion or group of conclusions, though it should also be appreciated that the organizing of information related to a single conclusion or group of conclusions is involved in at least some particular embodiments contemplated by the inventors. Embodiments of the process 700 may be performed by an apparatus, such as the apparatus 100 described with respect to FIG. 1, and as part of an application tagging framework depicted with respect to FIG. 2.

At action 702, first tag information is received from a first application. At action 702, second tag information is received from a second application. It should be appreciated that tag information may be received from each application in accordance with the various embodiments described above for providing tag information, application context information, and the like as described with respect to FIGS. 1-6. At action 706, the first tag information and the second tag information are associated with a particular tag group. Association with the tag group may occur at any time during the tag information capturing process. For example, in some embodiments, an interface may allow creation of a new tag group, and all tags created subsequent to selection of a new tag group may be associated with that tag group until the tag information is stored or the group is closed in the interface. In some embodiments, tags may be created individually and assigned to tag groups subsequent to creation of the tags. In some embodiments, an interface is provided for associating tags with particular groups using drop down boxes associated with each tag (e.g., to select a particular tag group), through the use of “look and feel” elements (e.g., all tags associated with a single display color are assigned to the same group), or via any other interface control, manual text entry, or the like. At action 708, the first tag information, the second tag information, and the association with the particular tag group are stored, such as in a tag datastore as described above with respect to FIG. 2.

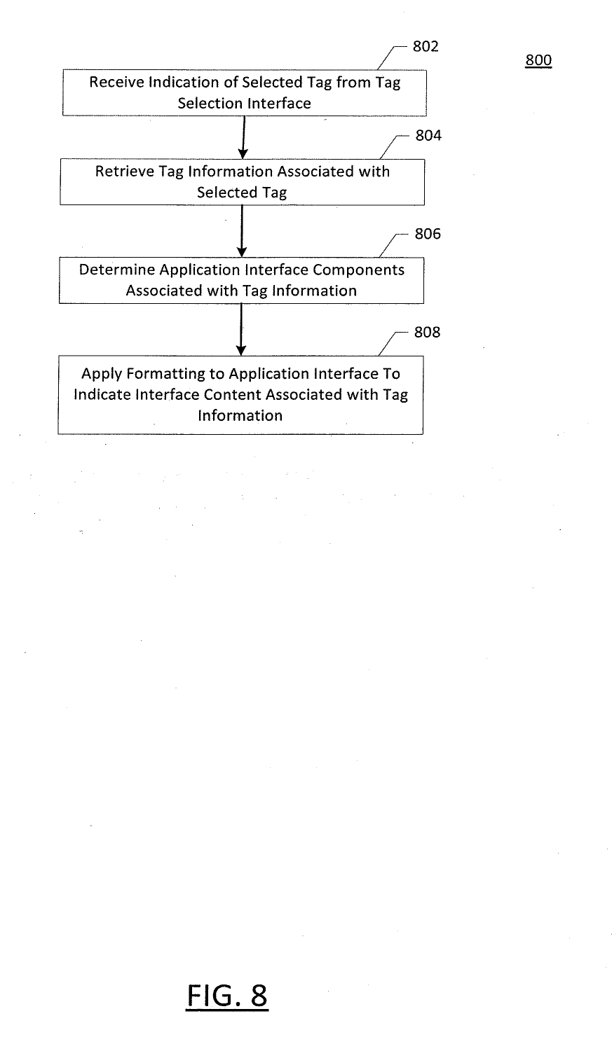

FIG. 8 is a flow diagram illustrating an example of a process for displaying tag information in accordance with embodiments of the present invention. As described above, some embodiments of the present invention are operable to allow selection of a particular tag. Upon selection of the tag, the tag information is processed and used to highlight portions of an application interface associated with the selected tag. The tag may also be associated with narrative information via the tag group (e.g., thought) that the tag is part of, indicating the conclusion derived from or other information associated with content indicated by the highlighted portions of the application interface. Embodiments of the process 800 may be performed by an apparatus, such as the apparatus 100 described with respect to FIG. 1, and as part of an application tagging framework depicted with respect to FIG. 2.

At action 802, an indicator of a particular tag is received via a tag selection interface. As noted above with respect to FIG. 2, embodiments may include a tag loader that provides an interface for selection of previously stored tags. Such an interface may include a search menu, a text input menu, a dropdown menu, or the like populated with previously stored tags, such that the interface may allow for selection of one or more of the stored tags via text entry, mouse click, gesture, or any other input mechanism. In some embodiments, selection of the tag may be performed within a particular application executing tagging logic, while in other embodiments the tag may be selected from a standalone application.

At action 804, tag information associated with the selected tag is retrieved. As noted above, the tag information may include application context information, information related to the portions of the application interface associated with the tag, information related to the look and feel of annotations to the application interface, an identifier of the particular application to which the tag is associated, or the like. At action 806, the particular portions of the interface associated with the tag are determined. For example, the tag information may provide details of annotated portions of the application interface in a relative format, such that if the application interface is displayed in a different location (e.g., the window has moved from when the tag was stored), then it may be necessary to calibrate the tag information to the new position of the application interface. As such, at action 806, a determination is made as to which portions of the application interface should have the tag information applied.

At action 808, formatting is applied to the application interface in accordance with the tagged information to highlight, annotate, or otherwise indicate the particular content within the display as indicated within the tag information. In this manner, the tag selection interface allows for selection of a particular tag and, upon that selection, highlighting of appropriate portions of an application interface corresponding to the selected tag.

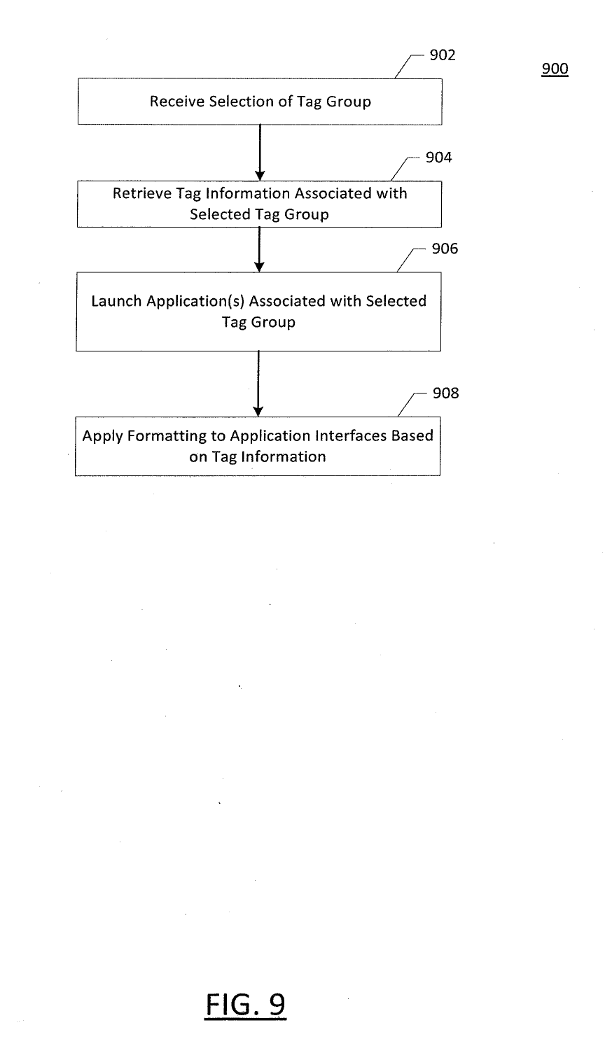

FIG. 9 is a flow diagram illustrating an example of a process 900 for viewing a tag group in accordance with embodiments of the present invention. As described with respect to FIG. 8, selection of a particular tag may result in that tag being displayed within an application interface. As noted above with respect to FIGS. 1-6, some embodiments provide for grouping of multiple tags. These tag groups may also include one or more narrative components illustrating the conclusion(s) to be drawn from the tagged content presented within application interfaces. For example, a conclusion might read “Diagnosis of <condition A> based on anomaly noted in <highlighted portion of Application B>, elevated levels in <lab result displayed in Application C>, and patient history of <condition noted in Application D>”. The tag group would thus highlight the relevant content within Applications B, C, and D, assuming the creator of the tag group had created the appropriate tag. Embodiments of the process 900 may be performed by an apparatus, such as the apparatus 100 described with respect to FIG. 1, and as part of an application tagging framework depicted with respect to FIG. 2.

At action 902, a selection of a tag group is received. Similarly to selection of a single tag as described above with respect to FIG. 8, an interface may be employed to select a tag group via a variety of methods. In some embodiments, selection of the tag group may be performed within a particular application executing tagging logic, while in other embodiments the tag group may be selected from a standalone application.

At action 904, tag information for the tags associated with the selected tag group are retrieved, such as from a tag datastore as described above with respect to FIG. 2. At action 906, one or more applications associated with the retrieved tag information are launched. For example, if a tag relates to a medical imaging application and that application is not running at the time of selection, embodiments may include logic for automatically launching that application in response to selection of the tag or a group containing the tag. Embodiments may also configure the application appropriately based on application context information associated with the tag, such as by opening particular files, adjusting display settings, adjusting a recording to a particular start time, or the like.

At action 908, each application interface associated with a tag is formatted according to the tag information for the tags of the selected tag group. As noted above, formatting of application interfaces may occur by sending commands to tagging logic executing within each application, by sending tag information to the tagging logic within each application, by applying an overlay or other graphical alteration of an area around the application interface, or the like. Once the application interfaces have been formatted, the interfaces should indicate which content is associated with the selected tag group. It should also be appreciated that embodiments may also include a display of a narrative associated with the tag group within one or more of the application interfaces or as part of a separate standalone interface.

It will be understood that each element of the flowcharts, and combinations of elements in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 104 of an apparatus employing an embodiment of the present invention and executed by a processor 102 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method for providing an application tagging framework, the method comprising:
receiving, via a tag selection interface, an indication of selection of at least one tag corresponding to a set of tag information stored in a tag information datastore;
accessing, using a tag loader element executing via a processor, the tag information datastore to obtain the set of tag information;
determining, by the tag loader element, one or more applications associated with the set of tag information;
generating, by the tag loader element, an instruction to each of the one or more applications based on the set of tag information, the instruction comprising data to cause a tagging component of each of the one or more applications to apply formatting to at least one component of a user interface to indicate content of the user interface associated with the set of tag information; and
transmitting the instruction to teach of the one or more applications.

2. The method of claim 1, wherein the at least one tag comprises a plurality of tags and wherein two or more of the plurality of tags are associated with different applications.

3. The method of claim 2, wherein the formatting applied to each of the different applications comprises at least one consistent formatting element.

4. The method of claim 3, wherein the at least one consistent formatting element is at least one of a color, a line quality, or a shading pattern.

5. The method of claim 1, where the one or more applications are at least one of a picture archiving and communications system application or an electronic health records application.

6. The method of claim 1, further comprising executing each of the one or more applications in response to receiving the indication of selection of the at least one tag.

7. The method of claim 1, wherein the set of tag information comprises application context information.

8. The method of claim 1, wherein the application context information comprises at least one of an open file or a display setting.

9. A method for providing an application tagging framework, the method comprising:
receiving, via an application interface operating in conjunction with a computer processor, a first set of tag information associated with a first application, the first set of tag information derived from at least one first annotation performed on an first application interface associated with the first application by a tagging component of the first application;
receiving, via the application interface, a second set of tag information associated with a second application, the second set of tag information derived from at least one second annotation performed on a second application interface associated with the second application by a tagging component of the second application;
receiving at least one narrative associated with both the first set of tag information and the second set of tag information;
storing the first set of tag information, the second set of tag information, the narrative, and an indicator of association among the first set of tag information, the second set of tag information, and the narrative in a tag datastore; and
providing an interface for selection of an identifier, such that selection of the identifier causes the first annotation to be performed on the first application interface and the second annotation to be performed on the second application interface.

10. The method of claim 9, wherein the first annotation and the second annotation share at least one consistent formatting element.

11. The method of claim 9, wherein the application context information comprises at least one of an open file or a display setting.

12. The method of claim 9, wherein causing the first annotation to be performed on the first application further comprises configuring the first application with the application context information.

13. An apparatus for providing an application tagging framework, the apparatus comprising:
a tag information datastore comprising a memory storing at least a set of tag information;
tag management circuitry configured to:
receive, via a tag selection interface, an indication of selection of at least one tag corresponding to a set of tag information stored in a tag information datastore;
access the tag information datastore to obtain the set of tag information;
determine one or more applications associated with the set of tag information; and
generate an instruction to each of the one or more applications based on the set of tag information, the instruction comprising data to cause a tagging component of each of the one or more applications to apply formatting to at least one component of a user interface to indicate content of the user interface associated with the set of tag information; and
tag/application interface circuitry configured to:
transmit the instruction to teach of the one or more applications.

14. The apparatus of claim 13, wherein the at least one tag comprises a plurality of tags and wherein two or more of the plurality of tags are associated with different applications.

15. The apparatus of claim 14, wherein the formatting applied to each of the different applications comprises at least one consistent formatting element.

16. The apparatus of claim 15, wherein the at least one consistent formatting element is at least one of a color, a line quality, or a shading pattern.

17. The apparatus of claim 13, where the one or more applications are at least one of a picture archiving and communications system application or an electronic health records application.

18. The apparatus of claim 13, wherein the tag management circuitry is further configured to execute each of the one or more applications in response to receiving the indication of selection of the at least one tag.

19. The apparatus of claim 13, wherein the set of tag information comprises application context information.

20. The apparatus of claim 13, wherein the application context information comprises at least one of an open file or a display setting.
